(19) United States
(12) Patent Application Publication
(10) Pub. No.: US 2017/0039246 A1
(43) Pub. Date: Feb. 9, 2017

(54) TEAM ANALYTICS CONTEXT GRAPH GENERATION

(71) Applicant: INTERNATIONAL BUSINESS MACHINES CORPORATION, Armonk, NY (US)

(72) Inventors: Paul R. Bastide, Boxford, MA (US); Matthew E. Broomhall, Goffstown, NH (US); Stephen Crawford, Dublin (IE); Andrew E. Davis, Arlington, MA (US); Eric S. Portner, Northborough, MA (US); Marco A. Vicente, Dublin (IE); Eric M. Wilcox, Los Altos, CA (US)

(21) Appl. No.: 14/817,426

(22) Filed: Aug. 4, 2015

(51) Int. Cl. G06F 17/30; H04L 12/58; H04L 12/26

(52) U.S. Cl. CPC G06F 17/30528; G06F 17/30958; H04L 43/045; H04L 51/046

(57) ABSTRACT

A method for team analytics context graph generation may include extracting, by a processor, a set of relevant features from a received message and evaluating the relevant features that represent a context of the received message. The method may also include retrieving, by the processor, artifacts from the received message that best represent the context of the received message based on the evaluation of the relevant features and generating a context graph based on the artifacts. The method may additionally include presenting, by the processor, the context graph.

### BACKGROUND

Aspects of the present invention relate to electronic communications, such as mail clients and online networks, and more particularly to a method, system and computer program product for team analytics context graph generation.

Mail Clients and Online Networks are a universal mechanism to connect people and information in logical and organized ways which enable sharing and processing of information between the users. The most common mechanisms of sharing and processing information are the inbox, wall, activity stream, timeline, or profile. These mechanisms enable a user to rapidly share information with others and gather information from others in the network. Each user of the network may create, read and respond to countless messages each day. As a result of such a large number of messages, a user may be unable to determine a context of a particular message when received. The user may have to review a considerable number of messages received earlier in order to determine the context of the particular message that was recently received. This can result in a considerable amount of time in reviewing messages that were previously received resulting in inefficiency. Additionally, there is no graphical representation of information to assist the user in determining the context of a new message and to automatically update information as new messages are received.

### BRIEF SUMMARY

According to one embodiment of the present invention, a method for team analytics context graph generation may include extracting, by a processor, a set of relevant features from a received message and evaluating the relevant features that represent a context of the received message. The method may also include retrieving, by the processor, artifacts from the received message that best represent the context of the received message based on the evaluation of the relevant features and generating a context graph based on the artifacts. The method may additionally include presenting, by the processor, the context graph.

According to another embodiment of the present invention, a system for team analytics context graph generation may include a processor and a module operating on the processor for team analytics context graph generation. The module may be configured to perform a set of functions including extracting a set of relevant features from a received message and evaluating the relevant features that represent a context of the received message. The set of functions may also include retrieving artifacts from the received message that best represent the context of the received message based on the evaluation of the relevant features. The set of functions may additionally include generating a context graph based on the artifacts and presenting the context graph.

According to another embodiment of the present invention, a computer program product for team analytics context graph generation may include a computer readable storage medium having program instructions embodied therewith. The computer readable storage medium is not a transitory medium per se and the program instructions are executable by a device to cause the device to perform a method including extracting a set of relevant features from a received message and evaluating the relevant features that represent a context of the received message. The method may also include retrieving artifacts from the received message that best represent the context of the received message based on the evaluation of the relevant features. The method may additionally include generating a context graph based on the artifacts and presenting the context graph.

### BRIEF DESCRIPTION OF THE SEVERAL VIEWS OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIGS. 1A-1B (collectively FIG. 1) are a flow chart of an example of a method for team analytics context graph generation in accordance with an embodiment of the present invention.

FIG. 2A is an example of a collaboration system graphical user interface including a feature for activating a team analytics context graph generation function in accordance with an embodiment of the present invention.

FIG. 2B is an example of the collaboration system GUI of FIG. 2A including a context graph in accordance with an embodiment of the present invention.

FIG. 2C is an example of the collaborative system GUI in FIG. 2B illustrating an example of an interactive feature associated with a node for presenting information associated with the node in accordance with an embodiment of the present invention.

FIG. 2D is an example of the collaborative system GUI in FIG. 2B including a context graph or a portion of the context graph illustrating an example of nodes without associated information in accordance with an embodiment of the present invention.

FIG. 2E is an example of the collaborative system GUI of FIG. 2B including a context graph illustrating an example of disconnected nodes or fragmented trees in the context graph in accordance with an embodiment of the present invention.

FIG. 3 is a block schematic diagram of an example of a system for team analytics context graph generation in accordance with an embodiment of the present invention.

### DETAILED DESCRIPTION

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

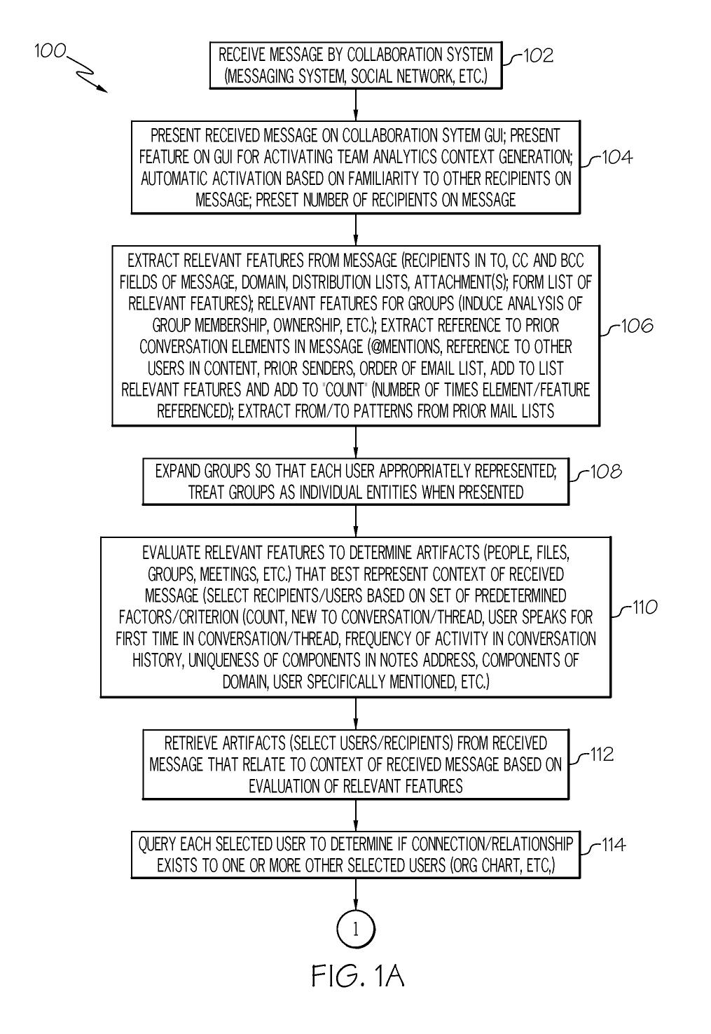

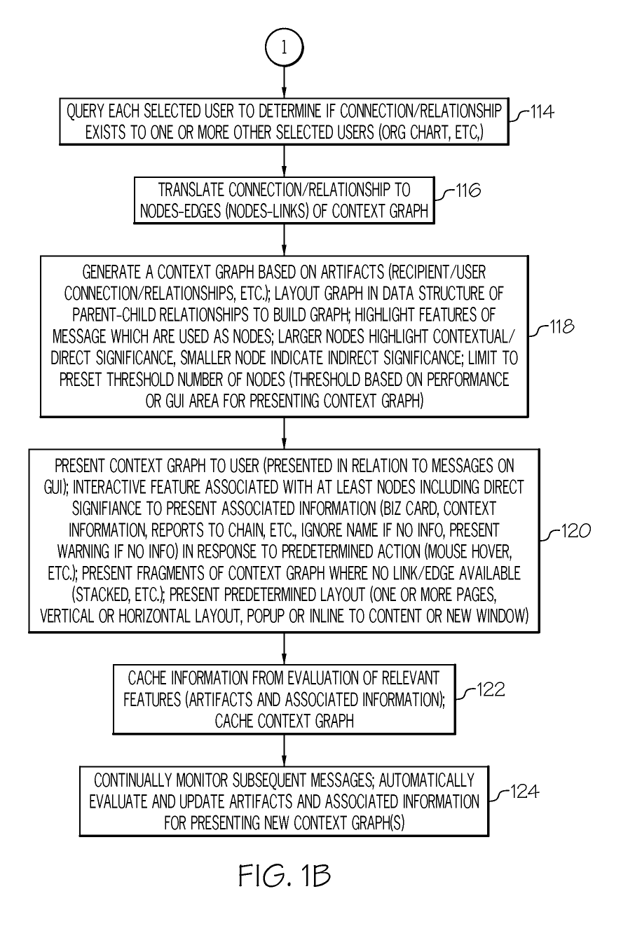

FIGS. 1A-1B (collectively FIG. 1) are a flow chart of an example of a method 100 for team analytics context graph generation in accordance with an embodiment of the present invention. In block 102, an electronic message may be received by a collaboration system. The collaboration system may be a messaging system, a social network or system or other electronic communications system or network, such as e-mail, instant messaging, chat or similar communications system or network. The social network or system may be an asynchronous network or a synchronous network. An example of an asynchronous network is Twitter where a user may follow communications generated by another user or person. Twitter is a trademark of Twitter, Inc. in the United States, other countries or both. An example of a synchronous network is IBM Connections. IBM Connections is a trademark of International Business Machines Corporation in the United States, other countries or both. The collaboration data may be associated with the message. Collaboration data may include, but is not necessarily limited to authors, editors, readers, followers, social connections, report-to-chains around each object, or other information that may be associated with collaboration between multiple users or participants. The collaboration data may be searched for and found based on relevant users. The collaboration system may include a collaboration application running on a communications device of a user, a collaboration module or program operating on a server or a combination of both. The user's communications device may be client computer system, mobile computer system or communications device, such as a smartphone or any other type communications device capable of performing the operations described herein.

In block 104, the received message may be presented on a graphical user interface (GUI) generated by the collaboration system. The collaboration system GUI may be presented on a display of the user's communications device. A feature may be presented on the collaboration system GUI for activating a team analytics context graph generation feature. In accordance with an embodiment, activation of the team analytics context graph generation may be automatically activated based on a predetermined criteria or set of factors or conditions. For example, the team analytics context graph generation feature may be automatically generated based on a familiarity of other recipients on the message. For example, the other recipients on the message may be known by the user that received the message and the recipients may be users that the user receiving the message has collaborated with before or collaborates with on a frequent basis. A preset number of recipients on the message may also be set for operation of the analytics context generation feature described herein.

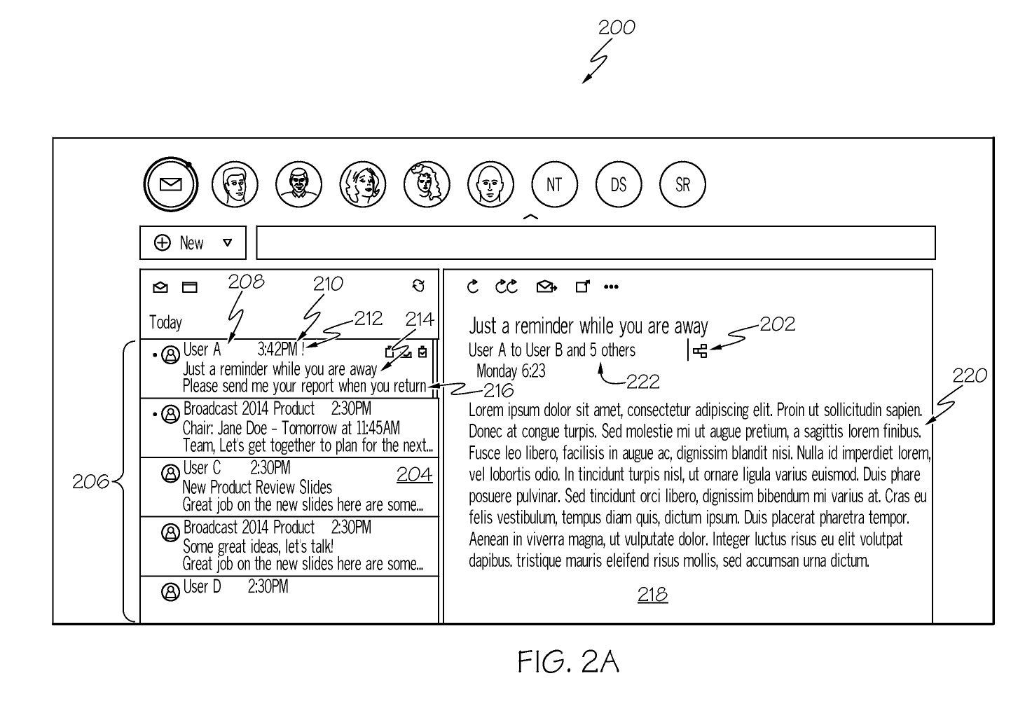

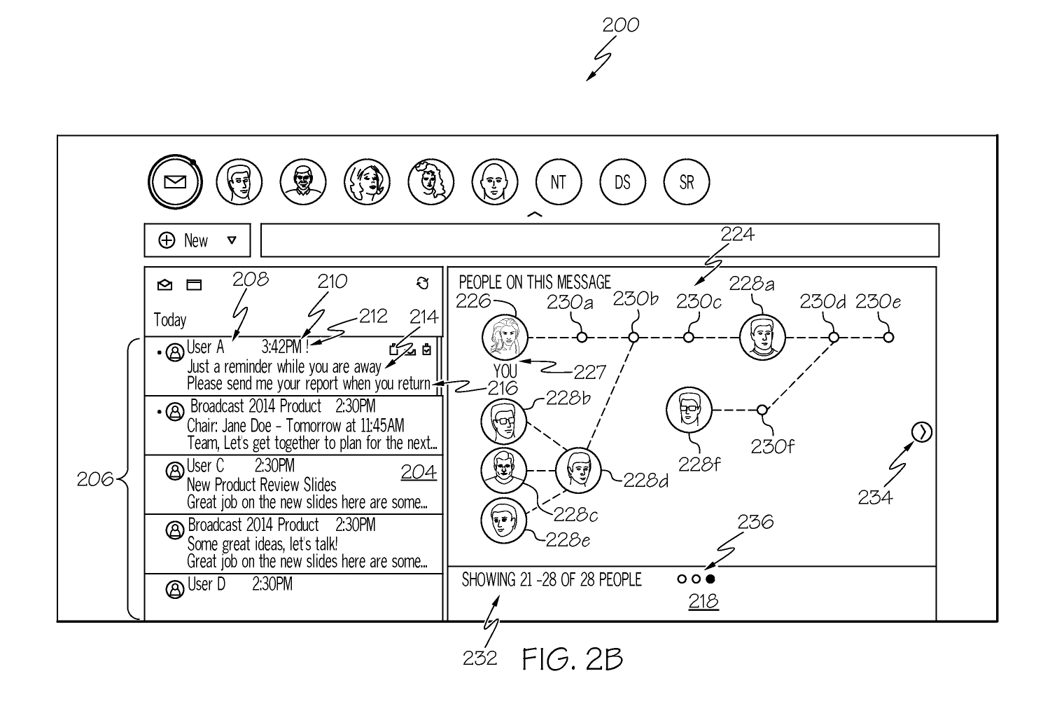

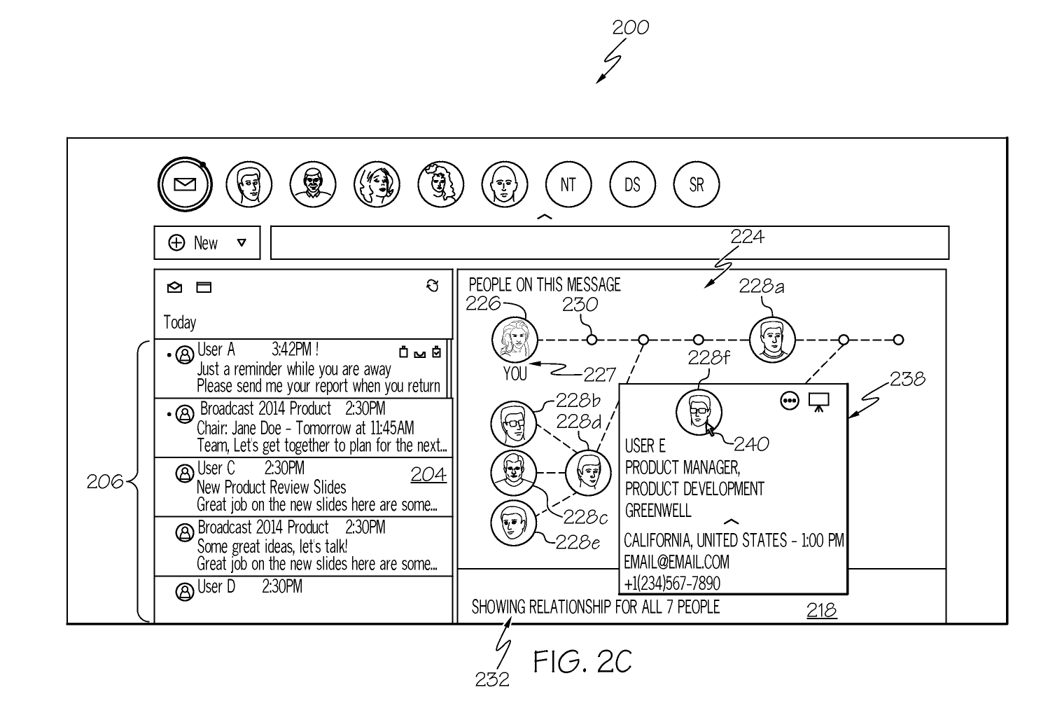

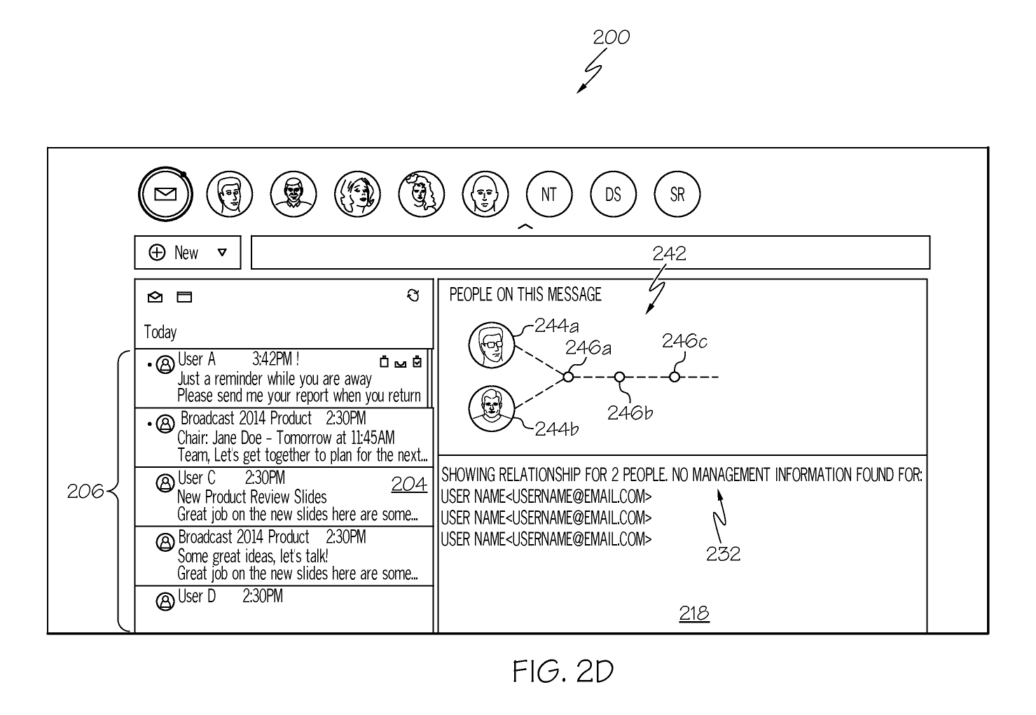

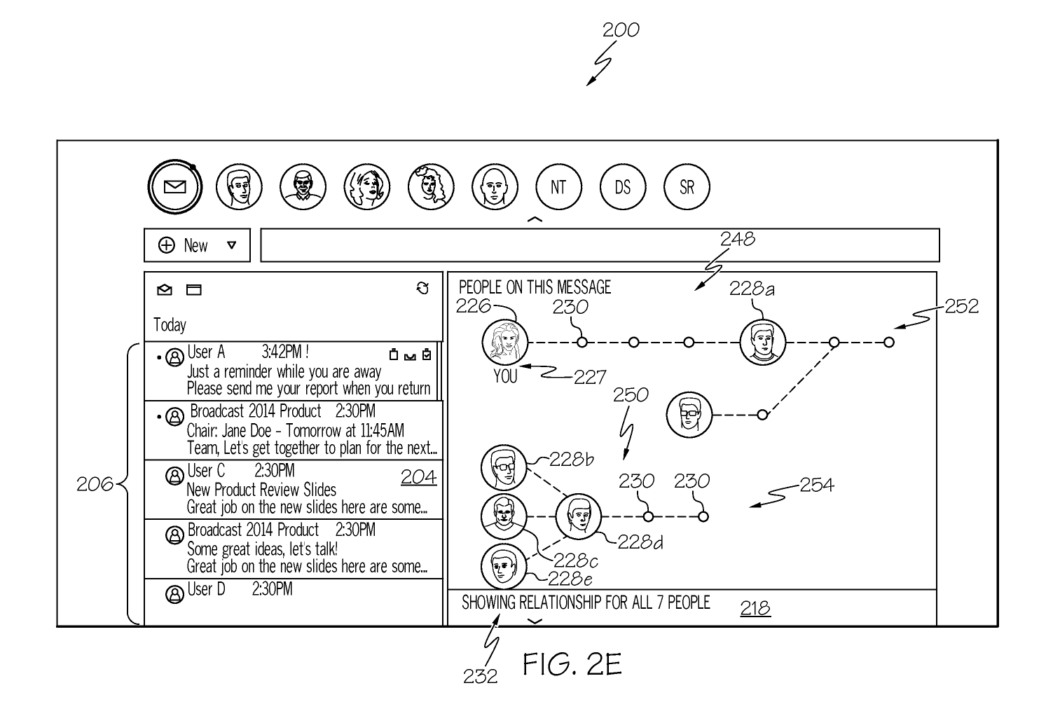

Referring also to FIG. 2A, FIG. 2A is an example of collaboration system graphical user interface (GUI) 200 including a feature 202 for activating a team analytics context graph generation function in accordance with an embodiment of the present invention. The collaboration system GUI 200 may include a first area 204 for presenting a list of messages 206 received by the collaboration system. The messages 206 may be presented in a predetermined order. For example, the messages 206 may be presented in chronological order based on the time received with the most recently received message listed first or at the top of the list of messages 206. Brief information associated with each message may be presented in the list of messages. For example, each message of the list of messages 206 may include an identification of a sender 208, a time 210 the message was received, a symbol 212 that may indicate an importance, urgency or other characteristic of the message, and a subject matter 214 of the message. The list of messages 206 may also include a limited amount of content 216 or a limited number of a first group of words of each message.

The collaboration system GUI 200 may also include a second area 218. The second area 218 may be used to present a currently open message 220 from the list of messages 206. The feature 202 for activating the team analytics context graph generation function may be presented in the second area 218 in association with the currently open message 220. Thus, the team analytics context graph generation function may be performed to generate a context graph corresponding to the currently open message 220 in response to activation the context graph feature 202. The feature 202 for activating the team analytics context graph generation function may be presented adjacent an identification of the sender and/or recipients 222 of the message 220.

Returning to FIG. 1A, in block 106, relevant features may be extracted from the received message. Examples of relevant features in the received message may include, but is not necessarily limited to, users or recipients identified in the “TO”, “CC” and “BCC” fields of the message, domains associated with the users or recipients, distribution lists, and attachments. A list of relevant features may be formed. Relevant features for groups may induce analysis of group membership or ownership or determination of other characteristics associated with a group.

The team analytics context graph generation function or system may also extract reference to prior conversation elements in the received message. Examples of prior conversation elements that may be found in a received message may include, but is not necessarily limited to @mentions or reference to other users in the content of the received message, prior senders of the received message, order of recipients in the e-mail list. The conversation elements may be added to the list of relevant features and a “count” may be incremented. A “count” or number of times an element or feature is referenced in the received message and other messages in a thread or conversation may also be tracked or monitored. A weight or ranking may be assigned to the conversation element based on the count. A conversation element or user associated with the conversation element may be used in generating a context graph based on the count, weight or ranking. For example, elements and/or associated users with a higher count, weight or ranking relative to other elements and/or users may be used in generating the context graph. From/To patterns may also be extracted from prior messages for use in generating the context graph.

In block 108, groups may be expanded so that each user or member of the group may be appropriately represented. Groups may be treated as individual entities when presented in a team analytics context graph.

In block 110, the relevant features may be evaluated to determine artifacts that best represent the context of the received message. Examples of artifacts may include, but is not necessarily limited to, identity of users, files associated with the message, groups associated with the message, meetings referenced in the message, and any other information from the message that may be evaluated to best represent the context of the received message. Users may be recipients of the message or other persons or individuals or groups identified or referenced in the message. Users may be selected as artifacts for creating the team analytics context graph based on a set of predetermined factors or criteria. A weight may be assigned to an identification or ID of a user based on the predetermined factors or criteria. For example, an ID of a user may be assigned a higher weight to make it more likely the user may be selected as an artifact in response to the user being new to the conversation. A higher weight may be assigned to the user's ID in response to the user being a new person to the recipient of the message or the user speaks or sends a message for the first time in the conversation or thread. A weight may be assigned to a user in proportion to the user's contribution to the conversation. For example, if the user's contribution to the conversation is long, the weight assigned to the user may be in proportion to their contribution. A weight may be assigned based on the familiarity of the user to the recipient of the message. For example, a higher weight may be assigned the less familiar the recipient of the message is with the user. A higher weight may be assigned if the user is unique to the conversation. For example, the user may have a different job role or may be in a different organization from other users or recipients of the message. A higher weight may also be assigned to users that are specifically addressed or identified in a salutation or greeting of the message or that are specifically mentioned in the message. Other examples of predetermined factors or criteria may include a count associated with a particular user, a frequency of activity in a history of the conversation.

In block 112, artifacts may be retrieved from the received message that relate to a context of the received message based on the evaluation of the relevant features. Retrieving the artifacts may include selecting a group of users based on the predetermined factors or criteria similar to that previously described.

In block 114, each selected user may be queried to determine if a connection or relationship exists to one or more other selected users. For example, an organization chart, such as a “reports-to-chain” or similar organization chart or directory may be used to determine connections or relationships between users or individuals selected as artifacts or nodes to be used in the team analytics context graph.

In block 116, the connections or relationships determined in block 114 may be translated into nodes and edges or nodes and links in the context graph. Each selected user of the group of users corresponds to a node and an associated connection or relationship between two selected users corresponds to an edge or link between the nodes corresponding to the two users. The graph layout may be done using IBM Rave Engine or other similar graphing program. IBM and IBM Rave Engine are trademarks of International Business Machines Corporation in the United States, other countries or both.

In block 118, the context graph may be generated based on the artifacts or selected users and connections or relationships between the artifacts or selected users. The layout of the context graph may be in a data structure of parent-child relationships to build the graph. Features of the received message, which are used as nodes in the context graph, may be highlighted or distinguished. For example, nodes that include or represent a contextual or direct significance may be larger nodes compared to nodes that include or represent an indirect significance which are smaller nodes. For example, contextual or direct significance nodes may correspond to users that are in the TO/CC/BCC list of the received message, and any file or collaboration artifact that is explicitly referenced in the received message. Examples of indirect significance nodes may be anyone who may be on an access control list (ACL) of an artifact or anyone who is connected to a direct significance user but not in the TO/CC/BCC list.

The context graph may be limited to a preset threshold number of nodes. The preset threshold may be based on performance or predetermined size of the area of the GUI for presenting the context graph.

In block 120, the context graph may be presented to the user. The context graph may be presented in relation to the list of messages on the collaboration system GUI, such as for example as a popup or inline to the content of the collaboration system GUI. In another embodiment, the context graph may be presented in a new GUI or window. The context graph may be presented in a predetermined layout. For example, the context graph may be presented on one or more pages depending upon the number of nodes and any limit to the number of nodes that may be presented on a page. Paging may be used to present the context graph as described in more detail with reference to FIG. 2B. The context graph may be presented in a vertical or horizontal layout.

Referring also to FIG. 2B, FIG. 2B is an example of the collaboration system GUI 200 of FIG. 2A including a context graph 224 being presented in relation to the list of messages 206 in accordance with an embodiment of the present invention. The context graph 224 corresponding to the message 220 in FIG. 2A may be generated and presented in response to activating the feature 202 associated with the message 220 in FIG. 2A. The context graph 224 may occupy the second area 218 of the collaboration system GUI 200. The particular user that is the recipient of the message for which the context graph 224 is being presented may be represented by a node 226 that is distinguishable from other nodes of the context graph 224. For example, the node 226 corresponding to the particular user or recipient may be identified or labeled as “You” 227. The node 226 corresponding to the recipient may also be enclosed by a predetermined geometric symbol, such as a circle as shown in FIG. 2B or other geometric symbol. The predetermined geometric symbol enclosing the node 226 may also be of a particular color relative to other nodes. The node 226 may also include a photograph of the recipient within the predetermined geometric symbol.

As previously, described, nodes 228a-228f that correspond to other users that have a contextual or direct significance may be distinguished from other nodes by being larger nodes. Each of these nodes 228a-228f may also contain a photograph of the user that corresponds to each node. Nodes 230 that correspond to users or artifacts that have an indirect significance are shown smaller in the context graph 200 compared to nodes 228a-228f that have a direct significance.

The context graph 200 may also include a summary 232 of what is being viewed in the context graph 200 or particular portion or page of the context graph 200 that is current being presented in the second area 218 of the GUI 200.

A page control mechanism 234 may be provided to control movement to a next or previous page or portion of the context graph 200. Similar to that previously described, a preset threshold or number of nodes may be presented on a page or portion of the GUI 200. A paging feature 236 may also be provided that indicates that the GUI 200 is configured for gallery style or horizontal paging control. The GUI 200 may also be configured for up/down or vertical paging control.

An interactive feature may be associated with at least nodes 228a-228f that represent a contextual or direct significance to present information associated with the node in response to a predetermined action, such as a computer pointing device hovering over the node or clicking on the node. Referring also to FIG. 2C, FIG. 2C is an example of the collaborative GUI 200 in FIG. 2B illustrating an example of the interactive feature 238 associated with the node 228f for presenting information associated with the node 228f in accordance with an embodiment of the present invention. In the example illustrated in FIG. 2C, the interactive feature 238 may present personal contact information or a business card for the user corresponding to node 228f in response to a computer pointing device represented by arrow 240 in FIG. 2C hovering over or clicking-on the node 228f. Other information that may be presented by the interactive feature may include, but is not limited to, context information, reports-to information and any other information that may assist the user viewing the context graph 200 in determining the context of the received message for which the context graph 200 was generated.

If there is no information associated with the node, no information may be presented or a warning that no information is available may be presented in response to hovering over or clicking-on the node. A name associated with the node may be ignored in response to no management information or other information associated with node being found in response to the query in block 114. FIG. 2D is an example of the graphical user interface 200 of FIG. 2B including a context graph 242 or portion of the context graph 224 illustrating an example of nodes 244a-244b and 246a-246c without associated information in accordance with an embodiment of the present invention.

The context graph may also be shown or represented in fragments where there is no edge or link available or associated with a node or group of nodes. Referring also to FIG. 2E, FIG. 2E is an example of the collaborative system GUI 200 of FIG. 2B including a context graph 248 illustrating an example of a group of disconnected nodes 250 or fragmented trees 252 and 254 in the context graph 248 in accordance with an embodiment of the present invention.

Referring back to FIG. 1B, in block 122, information from evaluation of the relevant features in block 110 may be cached. Accordingly, the retrieved artifacts and associated information resulting from evaluation of the relevant features may be cached for use in generating other contexts graphs or updated context graphs. The context graph, such as context graph 224 in FIG. 2B may also be cached. The cached context graph 224 may be updated as new messages are received.

In block 124, subsequently received messages may be continually monitored in response to the team analytics context graph generation feature being active. The relevant features may be automatically extracted and evaluated in response to new messages being received and updated artifacts and associated information may be retrieved similar to that described in blocks 110-116 for generating and presenting new and/or updated contexts graphs.

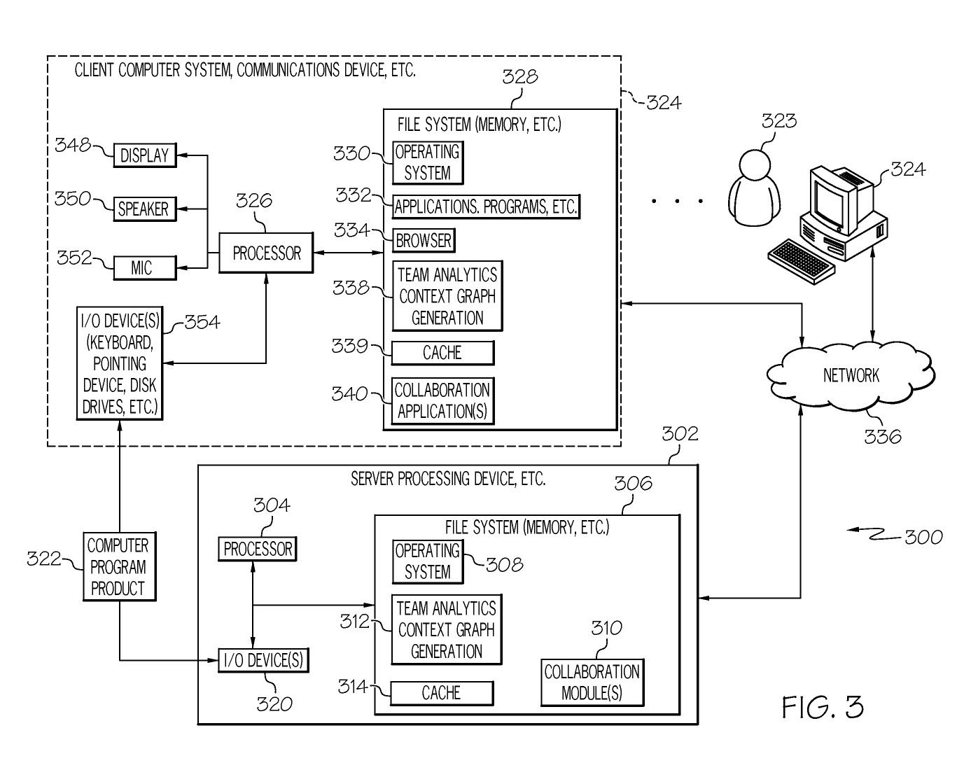

FIG. 3 is a block schematic diagram of an example of a system 300 for team analytics context graph generation in accordance with an embodiment of the present invention. The method 100 of FIGS. 1A-1B may be embodied in and performed by the system 300 and the exemplary GUIs 200 in FIGS. 2A-2E may be generated and presented by the system 300. The system 300 may include a processing device 302. The processing device 302 may be a server or similar processing device. The processing device 302 may include a processor 304 for controlling operation of the processing device 302 and for performing functions, such as those described herein with respect to method 100 in FIGS. 1A-1B. The processing device 302 may also include a file system 306 or memory. An operating system 308, applications and other programs may be stored on the file system 306 for running or operating on the processor 304. One or more collaboration modules 310 or systems may also be stored on the file system 306 and may be compiled and run on the processor 304 to perform the functions or operations described herein. The collaboration module 310 may be any type of online communications mechanism, networking arrangement or system for online communications or conversations, such as e-mail, instant messaging, chat or similar communications system or network.

A team analytics context graph generation module 312 may also be stored on the file system 306. The method 100 of FIGS. 1A-1B may be embodied in the team analytics context graph generation module 312 and performed by the processor 304 when the team analytics context graph generation module 312 is compiled and run on the processor 304. The team analytics context graph generation module 312 may operate in conjunction with the collaboration module 310. The team analytics context graph generation module 312 may be a separate component from the collaboration module 310 or in another embodiment, the team analytics context graph generation module 312 may be a component of the collaboration module 310.

The file system 306 may also include a cache 314 for caching information resulting from evaluation of the relevant features including artifacts, connections or relationships between artifacts, and context graphs similar to that previously described.

The processing device 302 may also include one or more input devices, output devices or combination input/output devices, collectively I/O devices 320. The I/O devices 320 may include, but are not necessarily limited to, a keyboard or keypad, pointing device, such as a mouse, disk drive and any other devices to permit a user to interface with and control operation of the processing device 302 and to access the collaboration module 310 or system and team analytics context graph generation module 312. At least one of the I/O devices 320 may be a device to read a computer program product, such as computer program product 322. The computer program product 322 may be similar to that described in more detail herein. The collaboration module 310 and team analytics context graph generation module 312 may be loaded on the file system 306 from a computer program product, such as computer program product 322.

A member of a network, such as a social network, or user 323 of the system 300 may use a computer system 324 or communications device to access the processing device 302 or server and collaboration module 310 and team analytics context graph generation module 312. The computer system 324 or communications device may be any sort of communications device including a mobile or handheld computer or communications device. The computer system 324 may include a processor 326 to control operation of the computer system 324 and a file system 328, memory or similar data storage device. An operating system 330, applications 332 and other programs may be stored on the file system 328 for running or operating on the processor 326. A web or Internet browser 334 may also be stored on the file system 328 for accessing the processing device 302 or server via a network 336. The network 336 may be the Internet, an intranet or other private or proprietary network.

A team analytics context graph generation application 338 may also be stored on the file system. The method 100 in FIGS. 1A-1B or at least portions of the method 100 may be embodied in and performed by the team analytics context graph generation application 338. The team analytics context graph generation application 338 may be compiled and run on the processor 326 to perform functions similar to those described with respect to method 100.

The file system 328 may also include a cache 339 for caching information resulting from evaluation of the relevant features including artifacts, connections or relationships between artifacts, and context graphs similar to that previously described.

One or more collaboration applications 340 may also be stored on the file system 328. The one or more collaboration applications 340 may be any type of online communications mechanism for online communications or conversations. The team analytics context graph generation application 338 may be a separate component from the collaboration application 340 as shown in the exemplary embodiment in FIG. 3 or in another embodiment, the team analytics context graph generation application 338 may be a component of the collaboration application 340.

The collaboration application 340 and the team analytics context graph generation application 338 operating on the computer system 324 may interface with or operate in conjunction with the collaboration module 310 and team analytics context graph generation module 312 on the processing device 302 or server to perform the functions and operations described herein. Accordingly, collaboration application 340 and team analytics context graph generation application 338 operating on the computer system 324 may perform some of the functions and operations of the method 100 and collaboration module 310 and team analytics context graph generation module 312 operating on the processing device 302 or server may perform other functions of the method 100. Some embodiments of the present invention may include only the collaboration module 310 and team analytics context graph generation module 312 on the processing device 302 or server, and other embodiments may include only the collaboration application 340 and team analytics context graph generation application 338 operating on the client computer system 324 or communications device.

The client computer system 324 or communications device may also include a display 348, a speaker system 350, and a microphone 352 for voice communications. Commands may be presented on the display 348 for controlling operation of the collaboration module 310 and team analytics context graph generation module 312 and/or team analytics context graph generation application 338 and collaboration application 340 and for performing the operations and functions described herein. The exemplary GUIs 200 in FIGS. 2A-2E may be presented on the display 348.

The computer system 324 may also include one or more input devices, output devices or combination input/output devices, collectively I/O devices 354. The I/O devices 354 may include a keyboard or keypad, pointing device, such as a mouse, disk drives and any other devices to permit a user, such as user 323, to interface with and control operation of the computer system 324 and to access the collaboration application 340 and collaboration module or system 310 on server 302. The I/O devices 354 may also include at least one device configured to read computer code from a computer program product, such as computer program product 322.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of embodiments of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for team analytics context graph generation, comprising:
extracting, by a processor, a set of relevant features from a received message;
evaluating, by the processor, the relevant features that represent a context of the received message;
retrieving, by the processor, artifacts from the received message that best represent the context of the received message based on the evaluation of the relevant features;
generating, by the processor, a context graph based on the artifacts; and
presenting, by the processor, the context graph.

2. The method of claim 1, wherein the artifacts are used as nodes in the context graph.

3. The method of claim 2, wherein nodes in the context graph that include a direct contextual significance are distinguished from nodes that include an indirect contextual significance.

4. The method of claim 3, wherein the nodes that include a direct contextual significance are larger than nodes that include an indirect contextual significance.

5. The method of claim 1, wherein the relevant features comprise recipients in a TO, CC and BCC fields of the message, a domain, a distribution list and an attachment of the message.

6. The method of claim 5, wherein evaluating the relevant features comprises determining artifacts that best represent the context of the received message based on a set of predetermined factors, the set of predetermined factors comprising a number of times a particular user is referenced, the particular user being new to a conversation or thread, a frequency of activity of the particular user in a history of the conversation, a component of a domain of the particular user, the particular user being specifically named.

7. The method of claim 1, wherein retrieving artifacts comprises selecting a group of users that relate to the context of the received message based on evaluation of the relevant features.

8. The method of claim 7, further comprising querying each user of the selected group of users to determine a connection or relationship to one or more other users of the selected group of users.

9. The method of claim 8, further comprising translating the connection or relationship of the group of users to nodes and edges of the context graph, wherein each user of the group of users corresponds to a node and an associated connection or relationship between two users corresponds to an edge between the nodes corresponding to the two users.

10. The method of claim 9, wherein at least nodes that include a direct contextual significance comprises an interactive feature, wherein information associated with the node is presented in response to activation of the interactive feature.

11. The method of claim 10, further comprising presenting one of no information associated with the node in response to there being no information associated with the node or presenting a warning in response to no information being associated with the node.

12. The method of claim 9, further comprising presenting the context graph in a plurality of fragments in response to no edge being available between a first set of nodes and a second set of nodes.

13. The method of claim 1, further comprising caching artifacts and associated information from evaluation of the relevant features.

14. The method of claim 13, further comprising:
continuously monitoring new messages being received;
automatically evaluating the relevant features of each new message; and
updating artifacts and associated information based on the evaluation for presenting a new context graph or graphs.

15. A system for team analytics context graph generation, comprising:
a processor;
a module operating on the processor for team analytics context graph generation, the module being configured to perform a set of functions comprising:
extracting a set of relevant features from a received message;
evaluating the relevant features that represent a context of the received message;
retrieving artifacts from the received message that best represent the context of the received message based on the evaluation of the relevant features;
generating a context graph based on the artifacts; and
presenting the context graph.

16. The system of claim 15, wherein the relevant features comprise recipients in a TO, CC and BCC fields of the message, a domain, a distribution list and an attachment of the message.

17. The system of claim 15, wherein retrieving artifacts comprises selecting a group of users that relate to the context of the received message based on evaluation of the relevant features.

18. The system of claim 17, wherein the set functions further comprises:
querying each user of the group of users to determine a connection or relationship to each other user of the group of users; and
translating the connection or relationship of the group of users to nodes and edges of the context graph, wherein each user of the group of users corresponds to a node and an associated connection or relationship between two users corresponds to an edge between the nodes corresponding to the two users.

19. A computer program product for team analytics context graph generation, the computer program product comprising a computer readable storage medium having program instructions embodied therewith, wherein the computer readable storage medium is not a transitory medium per se, the program instructions being executable by a device to cause the device to perform a method comprising:
extracting a set of relevant features from a received message;
evaluating the relevant features that represent a context of the received message;
retrieving artifacts from the received message that best represent the context of the received message based on the evaluation of the relevant features;
generating a context graph based on the artifacts; and
presenting the context graph.

20. The computer program product of claim 19, wherein retrieving artifacts comprises selecting a group of users that relate to the context of the received message based on evaluation of the relevant features.
